(19) United States
(12) Patent Application Publication
(10) Pub. No.: US 2015/0096707 A1
(43) Pub. Date: Apr. 9, 2015

(54) METHOD FOR POSITIONING AND FIXING MOLD PARTS IN CASTING MOLDS

(71) Applicant: ACTECH GmbH, Freiberg (DE)

(72) Inventors: Heike Hintze, Hainichen (DE); Andreas Knoch, Freiberg (DE)

(73) Assignee: ACTECH GmbH, Freiberg (DE)

(21) Appl. No.: 14/384,933

(22) PCT Filed: Mar. 11, 2013
(86) PCT No.: PCT/DE2013/100090

§ 371 Date: Sep. 12, 2014

(30) Foreign Application Priority Data
Mar. 12, 2012 (DE) 102012102047.7

(51) Int. Cl. B22D 33/04; B22C 9/06; G01B 11/00; B22C 9/02

(52) U.S. Cl. CPC B22D 33/04; B22C 9/02; B22C 9/06; G01B 11/00
USPC 164/4.1

(57) ABSTRACT

The position of the molding geometry of an assembled mold relative to a CAD data set is determined so the dimensional accuracy of the cast part to be produced can be evaluated. The position of the molding geometry of a first mold part is measured and compared to a desired position according to a CAD data set. The position is adjusted to optimally adapt it to within tolerances. The first mold part is maintained in its adjusted position while the position of the molding geometry of a second mold part is measured and compared to a desired position according to the CAD data set. The position of the second mold part is adjusted to optimally adapt it to within tolerances. Thereafter, the mold parts are fixed together with a curable molding material deposited into spaces in the mold parts that is allowed to harden.

### CROSS-REFERENCE TO RELATED APPLICATIONS

This application is a 371 U.S. National Stage of International Application No. PCT/DE2013/100090, filed Mar. 11, 2013. This application claims priority to German Patent′ Application No. 10 2012 102 047.7, filed Mar. 12, 2012. The entire disclosures of the above applications are incorporated herein by reference.

### FIELD

The production of cast parts often makes use of casting molds in which several mold parts are assembled into a complete mold. Such a multi-part mold can consist of lower boxes, upper boxes, side parts, outer cores, inner cores, chill molds, feeders and other parts which in the context of the present specification shall be subsumed under the term “mold part”.

### BACKGROUND

Such casting molds are already known in various configurations. For example, DE 20 2004 020 207 U1 describes a device for the casting of light metal cast parts which is assembled from several segments and which comprises in particular details for the positioning of various feeders.

A casting mold is known from DE 10 2006 055 988 A1 which comprises several telescopically embedded subassemblies which can be used to form various box and thus mold contours.

DE 10 2010 003 824 A1 concerns a casting mold box which comprises at least one lower box and one upper box, this document proposing in particular means of clamping the two boxes together.

DE 103 42 147 A1 describes a method for automatic calculating of a geometry of the mold cavity of an injection casting mold which compensates for deformations.

In DE 10 2007 050 316 A1 an injection casting mold is described which contains reserved areas which are used for a correction of the geometrical deviations occurring during the casting process.

Regardless of the particular configuration, the separate mold parts must first be positioned relative to each other in order to form the precise geometry of the cast part being formed in the cavity. Furthermore, the mold parts must also be fixed so that the achieved positioning remains intact until the casting takes place.

It is generally known that a positioning of the mold parts is done by rigid guide devices. Such rigid guide devices are designed primarily and worked into the particular mold part as an abutment surface, an elevation or a slot, these contours being known as core prints. The shape and dimension tolerances of these core prints as well as the position tolerance between the geometry of the structural part and the core prints in the individual mold parts ultimately determine the precision of the molding geometry of the structural part in the assembled mold.

The positioning of the mold parts relative to each other can be done in various ways, for example, by substantially exact core prints. If need be, further adaptation of the core prints is also possible. Likewise, one can use core supports with which the mold parts are forced into the desired position, for example, in order to ensure the required minimum wall thicknesses. Furthermore, clamping elements can be used, which force the mold parts into a desired position. During the positioning process, the position of the mold parts relative to each other is checked by optical or tactile measuring devices or also with auxiliary means, such as wall thickness verifiers or gauges. This checking is done by measuring specific measurement values or by using a “go/no go” gauge.

The fixation of the mold parts is done by the core prints and the natural weight of the parts and, if so required, by additional weightings. The mold parts are also fixed by mold boxes and interlocking devices. A fixation by clamping elements is also customary. Regardless of the particular configuration, exterior surfaces or cutting surfaces between the mold parts which are not part of the molding geometry are generally involved in the fixation process by force or form closure. The molding geometry means the areas of the mold parts which constitute a portion of the ultimate cast part's geometry. The sum of the shaping geometries of all mold parts belonging to a mold yields the complete geometry of the cavity of the ultimate cast part.

The casting molds assembled from several mold parts and the practices known for their positioning and fixation have basically worked well. Even so, there is a need for further development, especially in order to overcome the existing deficiencies by the use of new technical solutions which have come into being. Several principles in this regard shall be discussed below:

The mold design is done by means of CAD system. Thus, CAD data sets are in hand for the complete mold and all mold parts. This is a prerequisite for the use of modern manufacturing technologies.

Furthermore, modern measurement methods can be used to check the position of the mold parts in the assembled mold much more accurately, as compared to a positioning precision achieved with core prints. Due to the geometrically rigid core prints, corrections for the position of the mold parts are not easily possible. If a checking reveals a wrong positioning, the mold parts must be adjusted or the wrong position must be tolerated, or the mold must be scrapped.

Insofar as the mold parts are forced into the desired position by core supports, for example, this requires an increased assembly expense and additional costs for the core supports. In this process, unwanted stresses can occur in the mold parts, which may result in a breakage of the mold part. Moreover, the core supports remain in the cast piece, they cannot be recycled, and they may cause leakage and/or have a notch effect in the cast piece.

If the position of the mold parts is corrected by clamping elements, the necessary assembly expense and the costs are likewise increased. The clamping elements can also cause unwanted stresses in the mold parts, which can result in breakage of these mold parts. Moreover, the clamping elements must remain on the mold until after the cast piece has-solidified, so that a relatively large number of clamping elements is needed depending on the cadence. Furthermore, the clamping elements must be removed when the cast pieces are unpacked, which again increases the labor expense.

Insofar as the mold parts are fixed with clamping elements, the mold parts may be forced into an undesirable position within the mold due to the clamping forces which occur in an unfavorable circumstance, without this error being necessarily noticed.

If the position of the mold parts is corrected by post production adjustment such as rubbing down the core prints or by inlays in the core gap, this requires primarily labor-intensive process steps which do not lend themselves to automation.

The core prints themselves can be optimized by a pattern change. But this is cost-intensive and the core prints on the pattern are further worn down during use. Although the core prints on the pattern can be made from very wear-resistant materials (such as steel) and machined very precisely with CNC machines, the mold parts made with such a pattern still do not achieve the accuracy of modern manipulations and testing methods, because these mold parts are subject to changes in shape and dimension during the hardening, the storage and the machining process.

The molding geometry can be checked with optical or tactile measurement methods, but only on the not assembled mold. Accordingly, at least the position of the molding geometry of the last mold element which closes the mold cannot be measured with such optical or tactile measurement methods, unless a costly computer tomography is employed. This likewise applies to angled, complicated and deep-set shaping geometries.

### SUMMARY

The problem of the invention is to create a method with which a mold part for a casting mold can be positioned exactly and fixed in position in an easy manner. The molding geometry of the individual mold parts of a multi-part casting mold should be oriented for the most part exactly to the desired geometry according to a CAD data set. Furthermore, the actual position of the molding geometry of the completely assembled mold should be determined to enable an evaluation of the dimensional accuracy of the cast piece being produced on the bases of this data.

The problem is solved with the features according to patent claims 1 and 8. Advantageous configurations are the subject matter of subclaims, which are explained more closely in the sample embodiment.

The fundamental principle of the solution is to accomplish a positioning and fixation of the mold parts of a multi-part casting mold by comparing the mold part geometry against the predefined CAD data set and by filling in through-holes provided in all the mold parts. The mold is provided with through-holes that are present in all the mold parts. Thus, a through-hole in the mold is formed by through-holes in several separate mold parts. These through-holes are configured so that they are accessible from the outside during the respective assembly step.

In the course of the invention, the mold part is held in its desired position according to the CAD data set. In this process, the current position is measured and corrected to the desired accuracy. After the mold part has been positioned accurately, the through-holes are at first filled with a molding material. Once the molding material has hardened, the mold part need no longer be held in position, since it is now fixed in the optimal position relative to the other mold parts by the molding material filling up the through-holes.

A special configuration is provided for the assembly of the mold. For this, an optical measurement system is used preferably, with which the actual geometry of the mold part including the outer surfaces is measured. After this, the interior molding geometry of a mold part can be oriented by checking the position of the exterior surfaces. Accordingly, an orientation of the molding geometry according to the desired geometry of the CAD data set is also possible for the last mold part, which closes the mold and thus encloses the molding geometry and makes it inaccessible. The measurement of the overall mold part geometry can also be used for several mold parts or all of them.

The method according to the invention has many advantages over the present technical solutions, which are discussed below.

One major advantage is that a mold part, which always has a certain deviation in its molding geometry, can be positioned without predefined geometrical constraint by core prints so that the molding geometry is oriented optimally with respect to the shaping geometries of the already assembled mold parts. Thus, the existing deviations can be averaged out, and thereby a so-called best-fit adjustment is accomplished. Hence, this minimizes any residual geometrical deviation of the mold cavity's actual geometry with regard to the predefined CAD data.

Further adaptation of the core prints to improve the position of the mold parts is unnecessary, and since core prints are no longer needed for many configurations the mold design (CAD) can also be simplified. Patterns and mold parts are also simplified.

The actual position of the molding geometry of the mold elements is determined. As a result, there is created in the computer a model of the assembled mold. On this model, the geometry of the mold cavity can be easily checked, which would otherwise only be possible by costly computer tomography on the closed mold. In this way, defective molds can be quickly sorted out, i.e., even before the casting process. This accomplishes a higher precision and substantially lowers the reject rate of the cast pieces.

Another advantage is that the deviation only in terms of the molding geometry is always less than that in terms of the entire mold part. In the proposed method, there is no determination of position by core prints, so that no inaccuracies occur from form and position deviations between the molding geometry and the other regions of the mold part (such as core prints).

Furthermore, there is no error propagation, error summation or error intensification due to unfavorable angle relations and leverage effects in the proposed method. The more precise positioning thanks to avoiding error propagation is especially obvious in the case of an assembly of casting molds from many mold parts, since each individual mold part in this case can be oriented to the desired geometry according to the CAD data set.

Geometrical errors existing in the cutting surfaces between adjacent mold parts can be better balanced out, because these cutting surfaces are no longer essential to the positioning and fixation.

The position accuracy of the molding geometry in this method is limited only by the accuracy of movement of the auxiliary means employed and the accuracy of the testing devices for the determination of the geometry. In this way, the mold parts can be positioned very precisely.

The mold parts of a mold assembled according to the method are not subjected to any mechanical loading by clamping due to over determined, closely tolerated core prints. Accordingly, the mold parts once assembled are almost free of stress, which improves the stability of the mold. This also lessens the risk of breakage of a mold part due to the otherwise customary use of clamping elements and by stressing with additional weightings.

The fixation of the mold parts by the molding material filled into the through-holes and thereafter hardening produces a stress-free fixation and prevents a slippage of mold parts when subjected to forces.

Furthermore, the mold parts of a mold assembled according to the method have no clearance due to loosely tolerated core prints. This clearance-free positional fixation increases the accuracy as well as the rigidity of the mold and at the same time reduces a deformation in the mold upon transitioning from a loading by the natural weight of the mold parts in the empty mold to a loading due to the buoyancy in the filled mold.

Insofar as clamping elements are used, these can be removed again directly after the hardening of the molding material filling the through-holes in all the mold parts. Consequently, these clamping elements do not arrive at the casting and mold unpacking sections. Instead, the clamping elements can be removed with little effort directly during the mold assembly process and thus become immediately available once more. Since no core prints are used to define the position of the mold parts, no stresses are produced by the positioning of the mold parts with clamping elements.

### DRAWINGS

A sample embodiment of the invention is described below, making reference to the drawing. There are shown:

FIG. 1a, a first assembled casting mold from several separate mold parts

FIG. 1b, the mold parts of the casting mold of FIG. 1a, as separate individual parts

FIG. 1c, the mold parts of FIG. 1b in a partly preassembled arrangement

FIG. 2, a second assembled casting mold from several separate mold parts with coordinated measurement equipment and coordinated manipulator

FIG. 3, various views of the operative connection of casting mold and measurement equipment

FIG. 4a, a third assembled casting mold from several separate mold parts

FIG. 4b, the casting mold of FIG. 4a with an additional side part as the closure.

### DETAILED DESCRIPTION

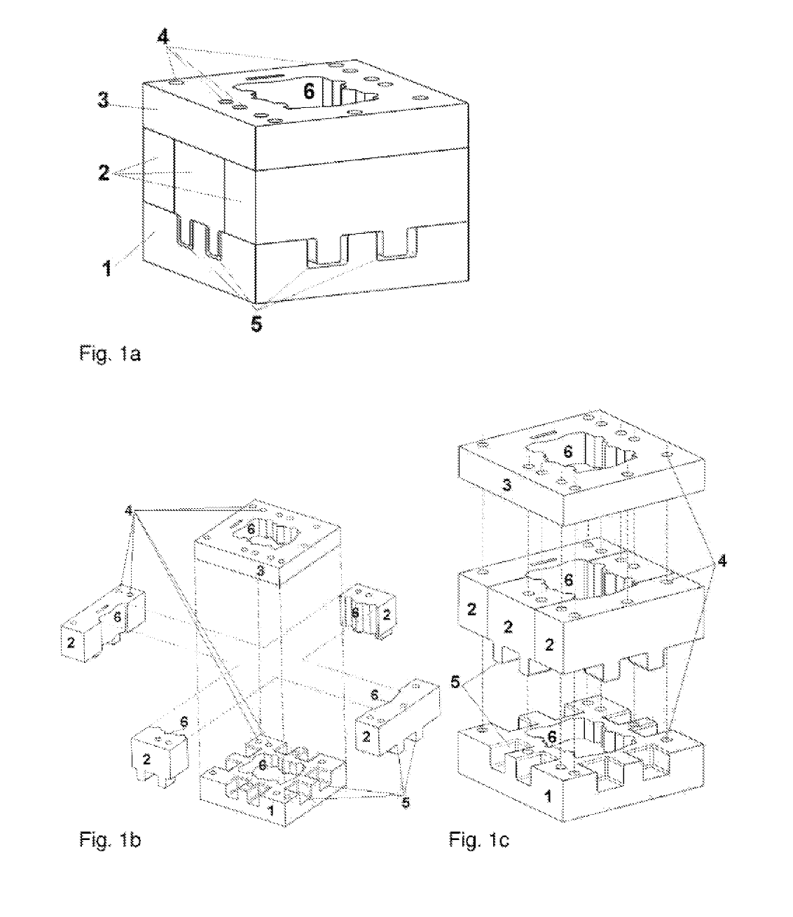

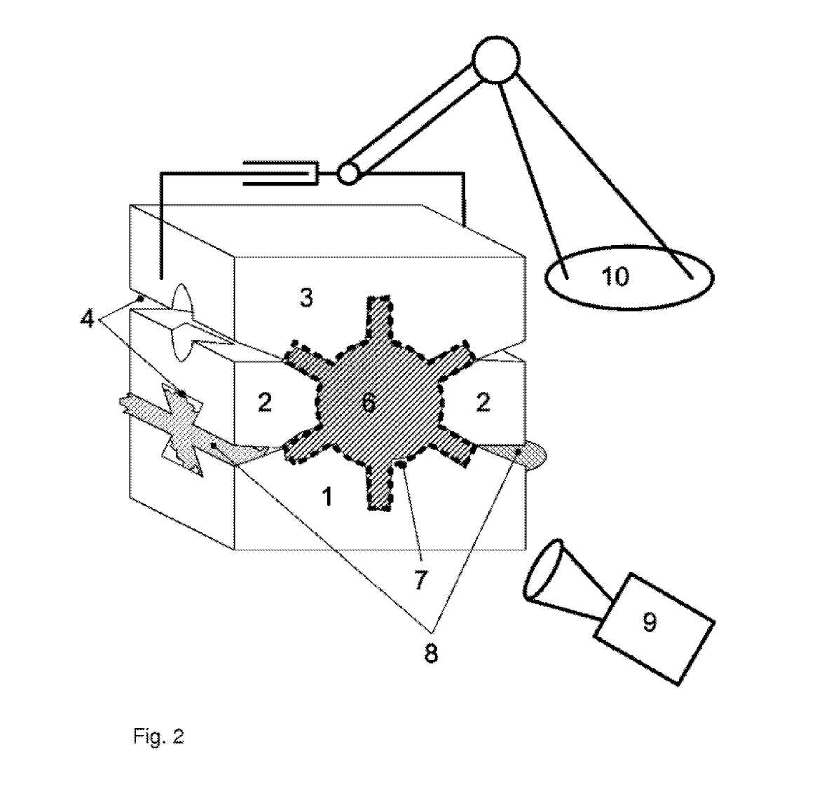

FIG. 1a shows a casting mold which is assembled from a lower box 1, several side parts 2 and an upper box 3. Through-holes 4 are provided in these structural parts, being configured here as boreholes. Furthermore, several guide devices 5 are provided in the transitional region between the lower box 1 and the side parts 2, having a clearance. On the other hand, no such guide devices 5 are provided between the side parts 2 and the upper box 3 in the sample embodiment shown here. The specific mold parting line can be realized in the form of a straight guide device, a plane, a segment of a cylindrical envelope surface, a conical section, a spherical section, or other geometry with at least one geometrical degree of freedom.

It is evident from FIG. 1b and FIG. 1c that the lower box 1, the side parts 2 and the upper box 3 each have a section with actual molding geometry 6. These actual shaping geometries 6 in the assembled mold (FIG. 1a) produce the cavity in which the melt solidifies into a cast piece. The geometry of this cavity determines the precision of the ultimate cast piece and should be produced as accurately as possible. For this, the individual actual geometry regions 6 must be positioned as accurately as possible relative to each other.

When building up a mold, one typically starts with a lower box 1. The lower box 1 is preferably used as a reference system, such that the actual molding geometry 6 is transposed by means of a coordinate transformation (in the three dimensions of space and the three spatial angles) until this actual molding geometry 6 is optimally adapted to the desired geometry 7 according to the CAD data set of the lower box 1. Alternatively, the desired geometry 7 according to the CAD data set of the lower box 1 can also be oriented according to the actual molding geometry 6. Afterwards, the desired geometry 7 and the actual molding geometry 6 of the lower box 1 remain unchanged relative to each other. The best possible fit is characterized in that the error dimension from the deviation between actual geometry 6 and desired geometry 7 of selected surfaces, here typically the entire molding geometry 6 of a mold part 1, 2 or 3, is minimal. In a coordinate transformation of the desired geometry 7, the accuracy with which the minimum error is achieved depends only on the numerics of the algorithm and the computer used and on the computing time. When orienting a mold part in terms of the desired geometry according to a CAD data set, the accuracy with which the minimum error is achieved also depends on the manipulation of the mold part and the number of measurements and corrections. If the orientation process is broken off after meeting a predetermined tolerance and before the minimum error is achieved, the orientation is termed true to specification.

After the lower box 1 and the desired geometry 7 have been oriented, the first side part 2 is held in proximity to its desired position. The guide devices 5 with their clearance are useful here. The actual position of the side part 2 is checked and the side part 2 is transposed in the three dimensions of space and the three spatial angles until its actual molding geometry 6 is a best possible fit for the desired geometry 7. This can be done, for example, by a robot/manipulator 10, with clamping elements, or by hand, the latter mentioned elements not being shown in the drawing.

Once the actual molding geometry 6 of the side part 2 is positioned with the required accuracy, the through-holes 4 are filled with molding material 8. After this molding material 8 has hardened, the side part 2 is fixed relative to the lower box 1 and can be released. Likewise, any clamping elements used can now be removed. After this, the next mold part—another side part 2 or the upper box 3—is held in proximity to its desired position and the process of positioning and fixing is repeated until the mold is completely built up. If several mold parts are accessible at the same time, these can also be positioned and fixed at the same time.

In the sample embodiment of FIG. 1a to FIG. 1c, the through-holes 4 are configured as boreholes which pass through several mold parts. If these boreholes after the orienting of the mold parts are not positioned precisely above each other this is no problem, because the molding material can also be filled into slightly offset boreholes and fills these boreholes completely with no clearance. Thus, the position of the mold parts is fixed after the molding material hardens.

Regardless of the particular configuration of the through-holes 4, these are mapped in the same manner into the mold parts as the molding geometry. This is done, for example, by molding, mold milling, laser sintering or mold printing. The through-holes 4 are filled with molding material before or during the orienting of the mold part, making use of the compressibility of the molding material for the adjustment process.

FIG. 2 shows a configuration in which the through-holes 4 are provided in the mold parting line and provided with an undercut. One variant is shown in which the desired geometry 7 has been oriented according to the lower box 1. The side parts 2 are oriented according to the desired geometry 7 and are fixed by molding material 8 in the lower through-holes 4. The upper box 3 is oriented according to the desired geometry 7 with a robot/manipulator 10.

Once the correct position of the upper box 3 has been determined with a measurement instrument 9—that is, a position in which the actual molding geometry 6 of the upper box 3 largely coincides with the desired geometry 7—the upper through-holes 4 between the side parts 2 and the upper box 3 are filled with molding material 8 and the robot/manipulator 10 releases the upper box 3 after the molding material 8 hardens.

Another variant embodiment calls for the use of a filling frame, which is built up around the mold so that the through-holes 4 result from the space between filling frame and exterior geometry 11.

The mold partitions can be designed with a wedge shaped expansion, starting from the actual molding geometry 6. Furthermore, inlays for the positioning of mold parts can be inserted in wedge-shaped mold partitions or also in core prints with wedge-shaped clearance, and these inlays also preferably have wedge-shaped contours.

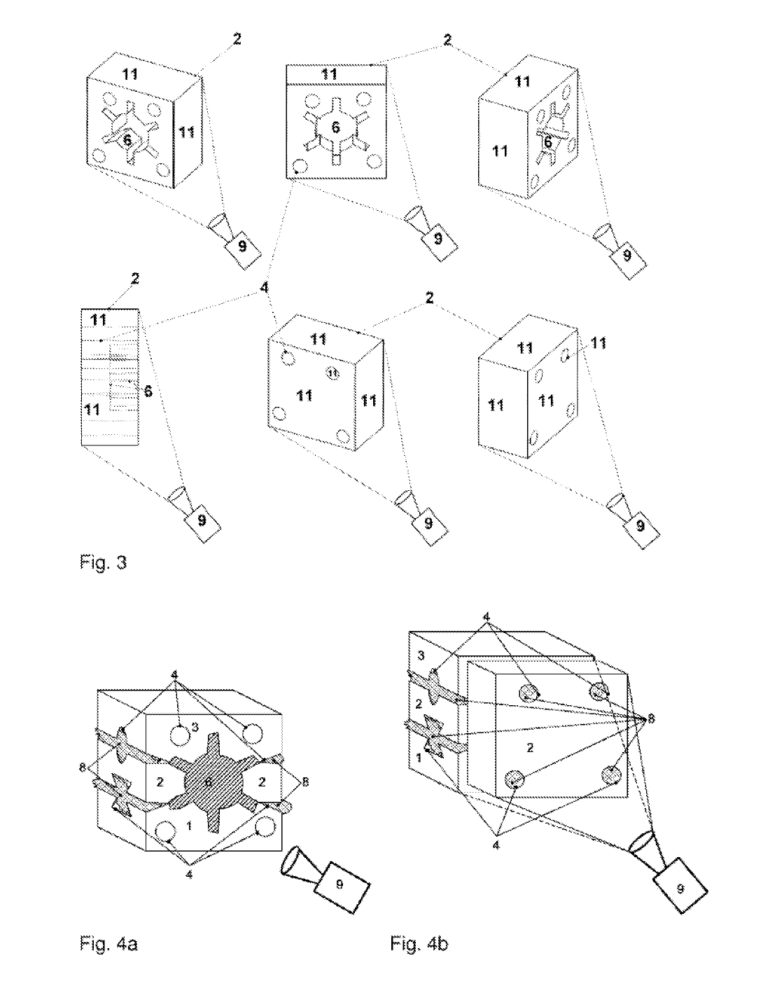

Another variant embodiment calls for a side part 2 closing the mold cavity formed by the actual molding geometry 6. According to FIG. 3, the actual geometry 6 of the side part 2 is checked with a measurement device 9 so that the position of the actual molding geometry 6 can be determined from the position of the exterior geometry 11 of the side part 2.

The measurement device 9 used is a device for optical geometrical determination, such as a fringe projector, a laser scanner or a computer tomograph. The optimal fitting of desired and actual geometry 6 and 7 by a continual checking during the assembly of a mold is known, for this see FIG. 4a.

After the mold has been closed by the side part 2, this side part 2 is positioned by a measurement of the exterior geometry 11 so that its actual molding geometry 6 best fits the desired geometry 7, for this see FIG. 4b. The various geometries, positions, and position relations are memorized, compared and displayed by computer, while deviations from the desired geometry can be shown both as a color representation and as numerical values. Furthermore, the adjustment, the actual position, and the needed correction movements are computed. The correction of the actual position is done by rotating and/or displacing the mold part, either manually according to correction values indicated by the computer or alternatively by a manipulator or robot according to the relayed correction values.

In a further configuration it is possible to check the actual geometry of the mold parts before or during the mold assembly and the actual position of the mold parts during or after the mold assembly. The molding geometries of the mold parts, likewise so checked, can be used to calculate a model of the actual mold cavity, which is used to judge the positioning of the mold parts.

Such a model of the mold cavity is calculated, for example, by a computer, in that the actual position of the molding geometries is calculated from the exterior accessible surfaces of the mold elements via the actual measured geometry of the mold parts. A surface model of the mold cavity is computed from the molding geometries of the individual mold elements, in their respective measured and/or calculated actual position. This surface model of the mold cavity constitutes a computer model of the future cast piece, taking into account the degree of shrinkage. This can be used to check the geometrical features of the raw part, such as wall thicknesses and the position of cavities, even before the casting process. The computer model of the cast piece can even be used to check surfaces which are not accessible on the real cast piece by conventional measurement methods.

The positioning of all mold parts can also be evaluated. This is done by a comparing of the desired mold cavity geometry according to the predefined CAD data set and the actual mold cavity geometry by means of a computer program and a best fit matching of the two geometries to each other and with a color representation of the deviation of the two geometries and/or an indication of the distance value of the corresponding surfaces to each other.

1. A method for positioning and fixing mold parts in casting molds, which comprise a plurality, but at least two, separate mold parts, wherein
first of all the actual geometry and the actual position of a first mold part are measured and compared with the predefined CAD data set of said mold part,
then the actual position and the desired position of said mold part relative to one another are corrected in such a manner that the molding geometry is adjusted within predefined tolerances to the desired geometry corresponding to the predefined CAD data set,
then the mold part remains in said position, which is subsequently used as the reference basis for positioning further mold parts,
wherein for further mold parts the actual geometry and the actual position are likewise measured and compared with the predefined CAD data set and then the respective actual position is corrected in such a manner that the molding geometry is adjusted within predefined tolerances to the desired geometry in accordance with the CAD data set, and
the mold parts have through-holes provided in all mold parts, which are in operative connection with adjacent mold parts and which are filled with a curable molding material which then cures and thus fixes the mold parts in the position corrected in accordance with the predefined CAD data set.

2. The method according to claim 1, wherein the actual geometry and the actual position are measured and represented by a device for geometrical determination and by means of a computer, while deviations from the desired geometry according to the CAD data set are shown as color representations and/or as numerical values and/or put out as control commands to a robot or manipulator.

3. The method according to claim 1, wherein at least one geometrical region configured for the positioning of a mold part is configured on at least one of the mold parts in operative connection with a clearance which is larger than the tolerance of the mold part.

4. The method according to claim 1, wherein mold partition lines, defined as cutting surfaces between adjacent mold parts, have the form of a straight linear guide device, a plane, a segment of a cylindrical envelope surface, a conical section, a spherical section, or another geometry with at least one geometrical degree of freedom.

5. The method according to claim 1, wherein mold partition lines, defined as cutting surfaces between adjacent mold parts, wedge shaped with an expansion, starting from the molding geometry, and inlays for the positioning of mold parts can be inserted in these sections.

6. The method according to claim 1, wherein the through-holes are configured as boreholes that pass through at least two mold parts.

7. The method according to claim 1, wherein the through-holes are arranged in mold partition lines, defined as cutting surfaces between adjacent mold parts.

8. The method according to claim 1, wherein the through-holes are formed by the exterior geometry of the mold parts in combination with a filling frame.

9. A method for determining the actual mold cavity geometry of casting molds, which comprise a plurality, but at least two, separate mold parts, wherein the actual geometry of the mold parts before or during the mold assembly and the actual position of the mold parts during or after the mold assembly is measured and compared to a predefined CAD data set, and a CAD model of the actual mold cavity, which is used to judge the positioning of the mold parts. is calculated from the ascertained molding geometries of the mold parts, which is used to judge the positioning of the mold parts within given tolerances.

10. The method according to claim 9, wherein the CAD model of the actual mold cavity is calculated by a computer, in that the actual position of the molding geometries is calculated from the exterior accessible surfaces of the mold elements via the actual measured geometry of the mold parts, and in that a surface model of the mold cavity is computed from the individual molding geometries of the individual mold parts in their respective measured and/or calculated actual position

11. The method according to claim 9, wherein the evaluation of the positioning is done by a comparing of the desired mold cavity geometry and the actual mold cavity geometry by means of a computer program and a best fit matching or a matching of the two geometries to each other in terms of the particular application and with a color representation of the deviation of the two geometries and/or an indication of the values of the distance of the corresponding surfaces to each other.

12. A method for positioning and fixing mold parts in casting molds that comprise at least two mold parts, the method comprising:
measuring the actual position of a molding geometry of a first mold part;
comparing the measured actual position of the molding geometry of the first mold part to a predetermined desired position for the first mold part;
adjusting the actual position of the first mold part relative to the desired position for the first mold part to a first adjusted position where the molding geometry of the first mold part is optimally adapted to within predetermined tolerances relative to a desired geometry for the first mold part;
maintaining the first mold part in the adjusted position;
measuring the actual position of a molding geometry of a second mold part;
comparing the measured actual position of the molding geometry of the second mold part to a predetermined desired position for the second mold part;
adjusting the actual position of the second mold part relative to the desired position for the second mold part to a second adjusted position where the molding geometry of the second mold part is optimally adapted to within predetermined tolerances relative to a desired geometry for the second mold part; and
fixing the second mold part to the first mold part.

13. The method according to claim 12, wherein the first mold part comprises a first space and the second mold part comprises a second space;
wherein the first space and the second space are operatively connected to one another when the first mold part is in the first adjusted position and the second mold part is in the second adjusted position; and
wherein fixing the second mold part to the first mold part comprises:
depositing a curable molding material into the first and second spaces; and
allowing the molding material to harden.

14. The method according to claim 13, wherein adjusting the actual position of the second mold part is performed subsequent to depositing a curable molding material into the first and second spaces.

15. The method according to claim 13, wherein the first and second spaces comprise holes extending through the first and second mold parts, respectively.

16. The method according to claim 13, wherein the first and second spaces comprise wedge-shaped openings at a partition between the first mold part and the second mold part.
